(19) United States
(12) Patent Application Publication
(10) Pub. No.: US 2019/0070802 A1
(43) Pub. Date: Mar. 7, 2019

(54) SMOOTH TEXTILE REINFORCEMENT FOR PULTRUSION, METHOD AND DEVICE FOR PRODUCING SAME, AND USE THEREOF IN THE MANUFACTURE OF COMPONENTS USING PULTRUSION

(71) Applicant: Gilbert Chomarat, Cologny (CH)

(72) Inventor: Gilbert Chomarat, Cologny (CH)

(21) Appl. No.: 16/080,348

(22) PCT Filed: Mar. 8, 2017
(86) PCT No.: PCT/IB2017/051351

§ 371 Date: Aug. 28, 2018

(30) Foreign Application Priority Data
Mar. 8, 2016 (FR) 16 51933

(51) Int. Cl. B29C 70/52; B29B 11/16; B29B 15/10; D04H 1/4218; D04H 1/593; D04H 1/60; D04H 3/004

(52) U.S. Cl. CPC B29C 70/52; B29B 11/16; B29B 15/105; B32B 5/26; D04H 1/593; D04H 1/60; D04H 3/004; D04H 1/4218

(57) ABSTRACT

A textile reinforcement that can be used for the creation of composite components by pultrusion, including a reinforcing layer having lengths of fiberglass oriented randomly and coated in a polyester binder. The reinforcing layer includes at least one reinforcement layer formed of fibers structured as a weave or as a mesh, or as longitudinal and transverse filaments. The reinforcing layer includes at least one thickness layer, adjacent to the reinforcement layer, and based on the lengths of fiberglass oriented randomly and coated in a polyester binder. At least one first surface layer as a web of fibers forms a first external face of the textile reinforcement. A second external face of the textile reinforcement is formed by the reinforcement layer or by a second surface layer as a web of fibers. The polyester binder binds the layers of the textile reinforcement together.

### TECHNICAL FIELD OF THE INVENTION

The present invention concerns textile reinforcements used as products for strengthening of composite articles, that is, articles based on resin (polyester or another one) strengthened with a textile reinforcement.

More especially the invention concerns textile reinforcements intended to make composite articles by a pultrusion process.

Pultrusion is a method of continuous shaping of plastics, including strengthening elements, having a constant cross section. During the pultrusion process, the product is drawn through a die during which the reinforcing elements are overmolded and impregnated with a resin. The resin is generally a thermosetting plastic. The die itself is heated. After leaving the die and cooling down, the product is cut to the desired lengths, thus forming profiled composite articles strengthened by the reinforcement elements.

The reinforcement elements are generally composed of fibers, and thus form a continuous textile reinforcement.

In its passage through the pultrusion die, the continuous textile reinforcement is subjected to braking forces, and it is necessary to place it under tension to ensure that it holds its shape. Thus, the pulling of the textile reinforcement through the die requires the applying of longitudinal driving forces to the continuous textile reinforcement, basically in traction.

At the same time, since pultrusion is a continuous process, it needs to use a continuous textile reinforcement, thus having a much larger longitudinal dimension than its transverse dimensions. As a result, under the action of a traction force, such an initially flat continuous textile reinforcement has a tendency to be deformed, producing undulations in the transverse direction, in the same way as a necktie is deformed when pulled downward. If such a deformation of the textile reinforcement occurs prior to entering the pultrusion die, it will reduce the width of the reinforcement and is liable to produce folds. This deformation of the reinforcement, and the resulting risks of defects, are more likely to occur when the reinforcement has a large width in relation to its thickness.

Continuous textile reinforcements which are based on continuous glass fibers are known, which are of interest in that they confer a great mechanical strength on the products made by overmolding of these reinforcements, thanks to the advantageous properties of glass fiber. These continuous reinforcements are generally in the form of a flat band. For example, one method of making such a continuous reinforcement is specified in the document U.S. Pat. No. 3,969,171: the glass filaments exiting from a glass extrusion die are assembled to produce glass threads which will be deposited in random fashion in every orientation on a conveyor belt. A binder is sprayed onto the glass threads, and then treated in an oven. This method is not able to control the direction of mechanical strength provided by the presence of the continuous glass threads and it does not provide a sufficient longitudinal mechanical strength for a pultrusion application.

Document WO 95/34703 A1 describes a textile reinforcement for making composite parts by pultrusion. This reinforcement comprises a layer based on glass fibers and polyester, in which the glass fibers are in the form of pieces of glass fiber coated with polyester and oriented in random fashion. When this reinforcement is used in a pultrusion process, the reinforcement needs to be combined with continuous longitudinal filaments (rovings) and exterior webs, the continuous longitudinal filaments having the function of conferring a sufficient mechanical resistance to elongation on the reinforcement to withstand the traction during the pultrusion. This significantly complicates the pultrusion process due to the need to assemble and hold several elements in position in the die. Moreover, with such a reinforcement structure it proves difficult to make profiles by pultrusion having a large width (at least 30 cm) and an acceptable quality, especially an acceptable transverse mechanical strength. Furthermore, difficulties are encountered in the subsequent use of such a reinforcement for a pultrusion method, and it would seem that these difficulties are caused by the fact that the introduction and progress of the reinforcement into and through the pultrusion die are disturbed by the inevitable presence of free ends of glass fiber segments which protrude from the surface of the reinforcement.

For these reasons in particular, the textile reinforcements which have been proposed thus far do not have a satisfactory structure which can withstand a pultrusion process and produce relatively wide profiled pieces.

### EXPLANATION OF THE INVENTION

One problem proposed by the present invention is thus to design a new structure of textile reinforcement which is particularly adapted to pultrusion processes, due to the fact that it has both good strength in longitudinal traction and good resistance to transverse deformations which are liable to occur during a pultrusion process, so that the textile reinforcement can be used during the pultrusion process without adding other strengthening elements such as continuous longitudinal threads in the die.

Another problem proposed by the present invention is to design a method and a device for producing a new structure of textile reinforcement based on glass fiber which is perfectly adapted to pultrusion processes.

In order to accomplish these as well as other goals, the invention proposes a textile reinforcement which can be used to make composite parts by pultrusion, comprising a reinforcement layer having segments of glass fiber oriented randomly and coated with a polyester binder, in which:
the reinforcement layer comprises at least one reinforcement layer formed of fibers structured by weaving, or by a grid, or by longitudinal and transverse threads,
the reinforcement layer comprises at least one thickness layer, adjacent to the reinforcement layer and based on said segments of glass fiber oriented randomly and coated with a polyester binder,
at least one first surface layer of fiber web forms a first external face of the textile reinforcement,
a second external face of the textile reinforcement is formed by said at least one reinforcement layer or by a second surface layer of fiber web,
the polyester binder bonds together the layers of the textile reinforcement.

Because the glass fiber segments of the thickness layer are coated in polyester and are combined with a reinforcement layer to form the reinforcing layer, the textile reinforcement has good resistance to transverse deformations during a pultrusion process.

The reinforcement layer allows the textile reinforcement to be given mechanical strength properties in the longitudinal direction and in the transverse direction. This significantly distinguishes the reinforcement according to the present invention from the reinforcements customarily used in the pultrusion techniques, which are basically formed of threads oriented in every direction and in random fashion. Such a known reinforcement necessarily has an insufficient longitudinal mechanical strength, requiring the adding of longitudinal glass fibers at the time of the pultrusion. But this adding of longitudinal glass fibers does not participate in the transverse mechanical strength of the reinforcement, which remains insufficient.

According to the invention, the reinforcement layer, structured so as to furthermore give the textile reinforcement properties of mechanical strength in the transverse direction, makes it possible to produce reinforcements of greater width, which are suitable to then make profiled pieces of great width by pultrusion, without the risk of untimely deformation.

At the same time, because the thickness layer based on the glass fiber segments which are oriented randomly does not in itself form any of the external faces of the textile reinforcement, and because these external faces of the reinforcement are formed either by a fiber web or by the reinforcement layer, the polyester binder, which bonds the layers of the textile reinforcement together at the same time gives the two external faces of the textile reinforcement a smooth nature.

The surface layer of fiber web forms a smooth outer surface, which can confer a particularly smooth and finished surface state on the composite part made by pultrusion based on the reinforcement thus constituted. In fact, the surface layer of fiber web, formed from relatively fine fibers, has a smooth appearance and hides the fibers of the central reinforcement layer. At the same time, the surface layer of fiber web forms an external reinforcement surface which facilitates the manufacturing of the reinforcement in that it avoids the sticking of the reinforcement to a conveyor belt during the course of its manufacture.

Moreover, the surface layer of fiber web can itself be made of colored fibers, which then give to the resulting pultruded products a colored appearance taking on the color of the surface layer of fiber web. Colored parts can thus be produced, and the changes in color from one production to another can be very easy by simply changing the surface layer of fiber web, without having to perform complex and costly cleaning of the die, for example, in order to change the color of the resin injected into the die.

Preferably, the glass fiber segments in said at least one thickness layer are pieces of fiber obtained from rovings of glass thread, which are commonly available products.

The glass fiber segments in the thickness layer may advantageously comprise glass threads having a linear weight of 40 to 50 tex, that is, of 40 to 50 grams per kilometer of thread. The glass fiber rovings can have a linear weight of 600 to 2400 tex.

Preferably, the polyester binder that binds together the layers of the textile reinforcement is an unsaturated bisphenol polyester, soluble or insoluble in styrene. This facilitates its melting to coat the glass fibers during the manufacture of the textile reinforcement.

Preferably, the threads or fibers making up the reinforcement layer are secured to each other, which facilitates the guiding and the penetration of the strengthening elements in the pultrusion die.

In the case of a grid, disjointed weft threads and disjointed warp threads are crisscrossed to form loose meshes, and are attached to one another by gluing at their junction points.

The benefit of a reinforcement layer structured as a grid is to ensure both good mechanical strength in the longitudinal direction and in the transverse direction, and to benefit from the very low cost of production of such a grid.

The fibers forming the reinforcement layer can advantageously be continuous glass threads, which can have an individual linear weight of 68 to 272 tex. Alternatively, rovings of continuous glass threads can be used, said rovings having a linear weight of the roving of 320 to 1200 tex.

According to one embodiment, the textile reinforcement according to the invention may comprise the superposition of a first surface layer of fiber web forming a first external face of the textile reinforcement, followed by a first thickness layer based on said segments of glass fiber coated with polyester binder, itself followed by a reinforcement layer forming a second external face of the textile reinforcement.

According to another embodiment, the textile reinforcement according to the invention may comprise the superposition of a first surface layer of fiber web forming a first external face of the textile reinforcement, followed by a first thickness layer based on said segments of glass fiber coated in polyester binder, itself followed by a first reinforcement layer, followed by a second thickness layer based on said segments of glass fiber coated with polyester binder, itself followed by a second reinforcement layer.

The surface layer or layers of fiber web can be made of polyester, polyamide, or polypropylene, it being noted that these are formed by a material whose melting point is higher than that of the polyester web binder that binds together the layers of textile reinforcement, for example, a melting point on the order of 250° C.

In the thickness layer or layers, the glass fiber segments can advantageously have a length of 40 to 120 mm. A good compromise is thus made between the ability of the fibers to be oriented in every direction in random fashion inside the textile reinforcement and the ability of the fibers to provide the textile reinforcement with great mechanical strength.

In practice, it could be arranged for the glass fiber segments to be present in the textile reinforcement in a quantity of 150 to 2000 grams per square meter.

Furthermore, in the thickness layer or layers the polyester binder could be present in a quantity of 3 to 5% by weight of the glass fibers.

According to another aspect, the present invention proposes a method of fabrication of a textile reinforcement usable in making composite parts by pultrusion, involving the following consecutive steps:

a) on top of a conveyor belt roving in the longitudinal direction, arrange a first web of fibers made of polyester, polyamide or polypropylene,

b) cut rovings of glass fiber and let them drop onto a first pin roller at the same time receiving a polyester resin powder, making drop onto said first web placed on the moving conveyor belt a first mixture of segments of glass fiber and polyester resin powder, the polyester resin being chosen so as to have a melting point lower than that of the fibers making up the first web,

c) arrange a first reinforcement layer of reinforcing fibers on the first mixture of glass fiber segments and polyester powder,

f) heat the assemblage by passing through an oven so as to melt the polyester resin and ensure its distribution around the glass fiber segments, yet without melting the fibers of the first web.

A particularly simple and economical method of making the textile reinforcement for pultrusion is thus realized.

In this way, advantageous mechanical properties can also be conferred on the textile reinforcement by selecting the orientation of the reinforcing fibers in the core.

Advantageously, prior to step f), provision may be made to:

d) cut rovings of glass fiber and let them drop onto a second pin roller at the same time receiving a polyester resin powder, in order to make drop onto the first reinforcement layer of reinforcing fibers carried by the moving conveyor belt a second mixture of glass fiber segments and polyester resin powder, the polyester resin being chosen so as to have a melting point lower than that of the fibers making up the first web,

e) arrange a second reinforcement layer of reinforcing fibers on the second mixture of glass fiber segments and polyester resin powder.

The first web can advantageously be obtained by carding, and have a surface density of 20 to 40 grams per square meter.

Preferably, the polyester resin used to make the thickness layer can consist of an unsaturated bisphenol polyester resin, soluble or insoluble in styrene, and in a quantity of 3 to 5% by weight of the glass fiber segments.

In practice, the polyester resin used in the thickness layer may have the property of melting when subjected to a temperature of 100° C. for two minutes.

Moreover, the polyester resin may be in the form of a dry powder or in the form of a powder emulsion in water.

The polyester web(s) used to make the external surface(s) may advantageously be colored, conferring on the reinforcement, and then on the pultruded material made from the reinforcement, a coloration in the mass, resistant to outside attack, without the need for supplemental coloring of the pultruded material itself.

According to another aspect, the present invention proposes a device for the fabrication of a textile reinforcement as defined hereinabove, the device comprising:
a conveyor belt providing movement between an entry roller and an exit roller,
near the entry roller, above the conveyor belt, a first web distributor for delivering a first web and for laying it on the conveyor belt,
downstream from the first web distributor, a first distributor of glass fiber rovings which can deliver glass fiber rovings to a first chopper,
at the exit from the first chopper, a first pin roller for breaking up the pieces of glass fiber rovings to produce glass fiber segments which are deposited on the first web,
a first powder distributor for distributing a polyester resin powder on the first pin roller so that the polyester resin powder mixes with the glass fiber segments to form a first mixture during the depositing onto the first web,
downstream from the first pin roller, a first reinforcement layer distributor for arranging a first reinforcement layer on the first mixture of fiber segments and powder present on the conveyor belt,
downstream from the first reinforcement layer distributor, above the conveyor belt, a second glass fiber roving distributor which can deliver rovings of glass fiber to a second chopper, at the exit from the second chopper a second pin roller for breaking up the pieces of glass fiber rovings and producing glass fiber segments, a second powder distributor for distributing a polyester resin powder on the second pin roller so that the polyester resin powder mixes with the glass fiber segments to form a second mixture which is then arranged on the first reinforcement,
downstream from the second pin roller a second distributor able, as an operator so chooses, to deliver either a second reinforcement layer or a second web which it arranges on the second mixture coming from the second pin roller,
an oven able to heat the elements placed on the conveyor belt,
downstream from the oven, one or more pressing rollers able to press the materials moving on the conveyor belt.

Preferably, the second distributor is arranged downstream from the oven. In that way, the resin can be heated by infrared heaters the effectiveness of which is not disturbed by the presence of a reinforcement layer, which is itself laid after heating.

According to another aspect, the present invention proposes the use of a textile reinforcement as defined hereinabove to form a pultruded product. During this use, the textile reinforcement considered in isolation is impregnated with a thermosetting plastic resin, and said impregnated textile reinforcement is drawn through a pultrusion die heated to a temperature that allows the thermosetting plastic resin to cross-link. In this regard, the thermosetting plastic resin may be a polyester resin, a polyurethane resin, and epoxy resin, for example.

### BRIEF DESCRIPTION OF THE DRAWINGS

Other objects, characteristics and advantages of the present invention will emerge from the following description of particular embodiments, given in regard to the enclosed figures, in which:

FIG. 1 is a schematic side view in longitudinal section of a textile reinforcement according to a first embodiment of the invention;

FIG. 2 is a schematic view in transverse section of the textile reinforcement of FIG. 1;

FIG. 3 is a schematic side view in longitudinal section of a textile reinforcement according to a second embodiment of the invention;

FIG. 4 is a schematic view in transverse section of the textile reinforcement of FIG. 3;

FIG. 5 is a schematic side view in longitudinal section of a textile reinforcement according to a third embodiment of the invention;

FIG. 6 is a schematic top view of the textile reinforcement according to any of the preceding figures; and

FIG. 7 is a schematic side view illustrating a device and a method for making the textile reinforcement of FIGS. 1 to 6.

### DESCRIPTION OF PREFERRED EMBODIMENTS

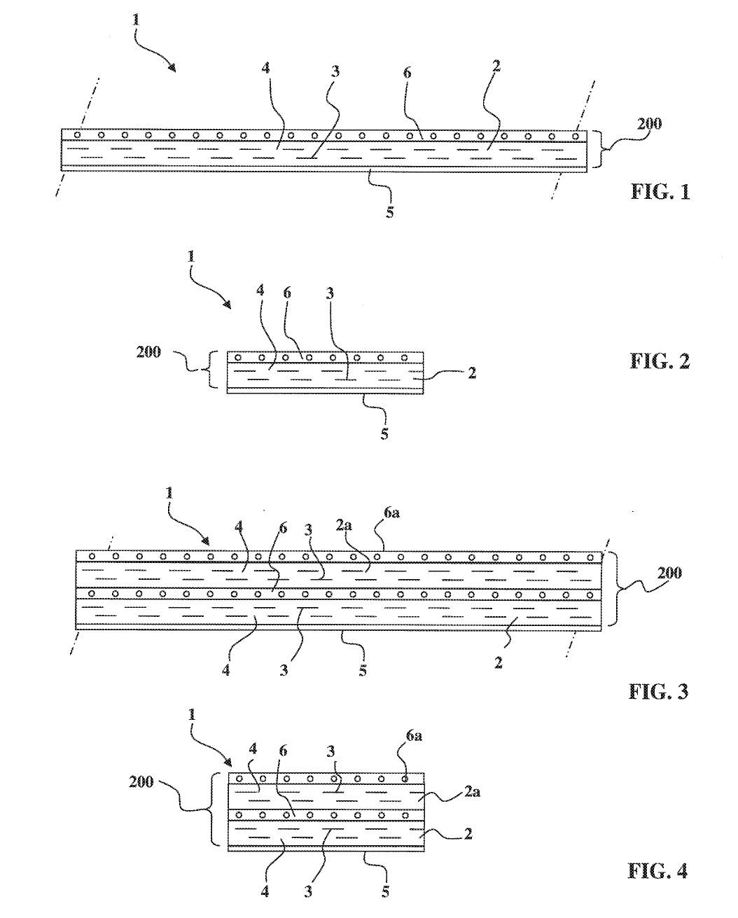

In the embodiment illustrated in FIGS. 1 and 2, the textile reinforcement 1 comprises a reinforcing layer 200 and a surface layer 5. The surface layer 5, of fiber web, forms one of the external faces of the textile reinforcement 1, in the present instance, the lower external face.

The reinforcing layer 200 comprises the combination of a reinforcement layer 6 and a thickness layer 2.

The thickness layer 2 is based on segments of glass fiber 3 coated in a polyester binder 4. The glass fiber segments 3 are rovings of single-strand thread pieces, having a linear weight of 40 to 50 tex, and oriented in random manner between the longitudinal direction and the transverse direction of the textile reinforcement 1.

The polyester binder 4 coating the glass fiber segments 3 is an unsaturated bisphenol polyester, whose melting point is on the order of 100° C., lower than the melting point of the synthetic material composing the surface layer 5.

The surface layer 5 may be made of polyester, polyamide, or polypropylene, reserving the fact that its melting point is higher than that of the polyester making up the thickness layer 2. A melting point of the fibers of the surface layer 5 can be, for example, around 250° C.

The reinforcement layer 6 is formed of fibers basically oriented in the longitudinal direction and in the transverse direction of the textile reinforcement 1.

In order to guarantee good mechanical strength under longitudinal traction, the reinforcement layer 6 can basically consist of longitudinal threads. The polyester binder 4 surrounding the glass fibers 3 ensures a good mechanical strength resisting the transverse deformation of the textile reinforcement 1.

In order to guarantee at the same time a good mechanical strength in the transverse direction of the reinforcement, the reinforcement layer 6 is preferably formed of fibers structured by weaving, or by a grid, thus comprising warp threads and weft threads. The advantage of the grid is that it is more easy and quick to produce than the weaving.

Preferably, the fibers in the reinforcement layer 6 are secured to each other, by gluing, to facilitate the passage through the pultrusion die when the textile reinforcement 1 is used to make a profiled piece by pultrusion.

A textile reinforcement 1 according to the invention with reinforcement layer comprising warp threads and weft threads provides a satisfactory mechanical strength not only in the longitudinal direction but also in the transverse direction, allowing such a textile reinforcement 1 to be used to make profiled pieces of greater width.

It will be noted, in this first embodiment of FIGS. 1 and 2, that the reinforcement layer 6 is the second external face of the textile reinforcement 1. In that way, the thickness layer 2 based on glass fiber segments 3 is enveloped between the first surface layer 5 and the reinforcement layer 6.

In the second embodiment, illustrated in FIGS. 3 and 4, the elements of the embodiment of FIGS. 1 and 2 are found again. Thus the reinforcing layer 200 and the first surface layer 5 of fiber web are again found. Also found again, in the reinforcing layer 200, are a first reinforcement layer 6 and a first thickness layer 2, said first thickness layer 2 being based on glass fiber segments 3 and polyester binder 4. The difference lies in the additional presence, in the reinforcing layer 200, of a second reinforcement layer 6a and a second thickness layer 2a, these respectively being of the same structure as the first reinforcement layer 6 and the first thickness layer 2.

The second reinforcement layer 6a forms the second external face of the textile reinforcement 1. In that way, the thickness layers 2 and 2a based on glass fiber segments 3 are enveloped between the first surface layer 5 and the second reinforcement layer 6a.

In the third embodiment illustrated in FIG. 5, a reinforcing layer 200 and a first surface layer 5 of fiber web are likewise again found. The difference, in comparison with the first embodiment of FIGS. 1 and 2, lies in the presence of a second surface layer 7 of fiber web, which may be made of the same synthetic material as the first surface layer 5.

At least one of the two surface layers 5 and 7 can itself be colored in the mass.

According to a variant of the second embodiment of FIGS. 3 and 4, a second surface layer, similar to the surface layer 7 of the embodiment of FIG. 5 may also be provided, on top of the second reinforcement layer 6a and itself forming the second external face of the textile reinforcement 1.

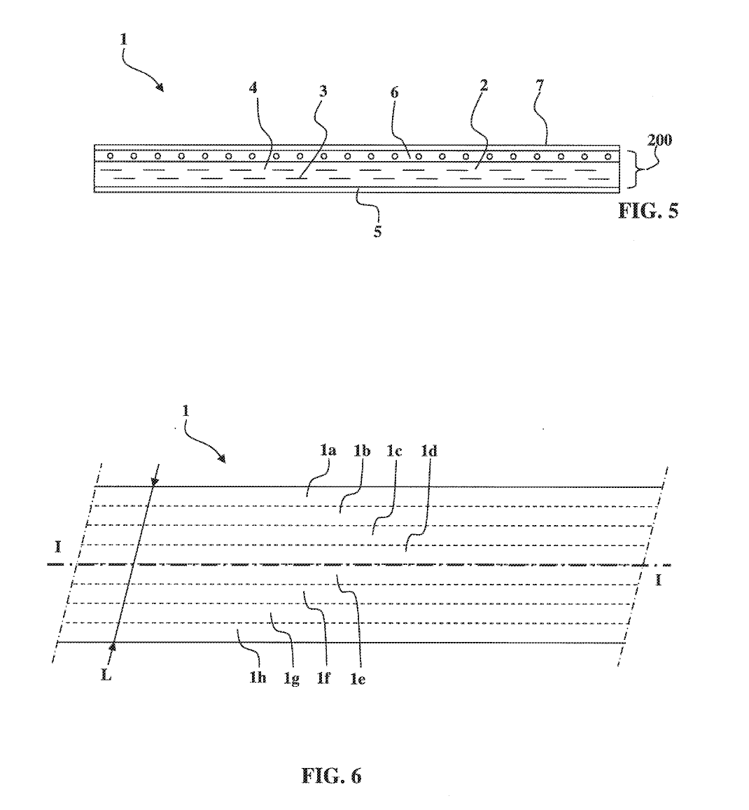

As can be seen in FIG. 6 in top view, the textile reinforcement according to the invention can be fabricated in the form of a wide band, extending longitudinally along an elongation axis I-I, and of width L consistent with the manufacturing capacities of the customary apparatus for production of textile reinforcements. For example, the width L may be around 2 to 3 m, while the length along the axis I-I may be much greater, and the reinforcement may be wound on a reel.

In this figure, the fact is illustrated that the textile reinforcement 1 can then be sliced longitudinally along the dotted lines to form bands 1a, 1b, 1c, 1d, 1e, 1f, 1g, and 1h, each of them constituting a pultrusion reinforcement to make a profiled piece.

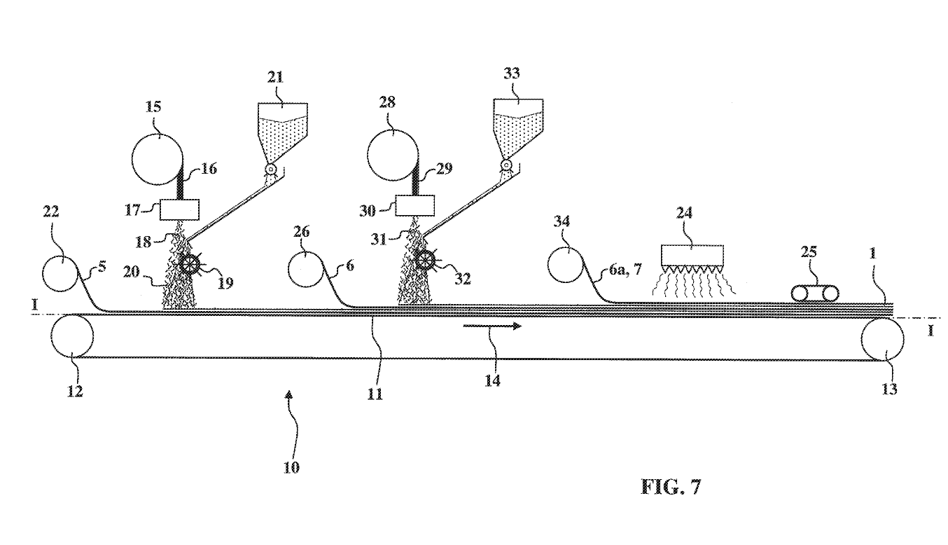

Now considering FIG. 7, which represents schematically a device for the fabrication of a textile reinforcement 1 according to the present invention and at the same time illustrates the method of fabrication of the textile reinforcement 1.

The device 10 represented in this figure comprises a conveyor belt 11, for example in the form of a conveyor band moving between an entry roller 12 and an exit roller 13 in a longitudinal direction I-I as shown by the arrow 14. Near the entry roller 12, above the conveyor belt 11, there is located a first distributor of glass fiber rovings 15 which can deliver glass fiber rovings 16 to a first chopper 17. The pieces of glass fiber rovings 18 emerging from the first chopper 17 are sent to a first pin roller 19 which breaks up the pieces of glass fiber rovings to produce glass fiber segments. At the same time, a first powder distributor 21 distributes a polyester resin powder on the first pin roller 19, which first pin roller 19 at the same time accomplishes the mixing 20 of the powder with the glass fiber segments.

Upstream from the first pin roller 19 there is provided a first web distributor 22 to generate a first web 5 and to arrange it on the conveyor belt 11.

Furthermore, downstream from the first pin roller 19, there is provided a first reinforcement layer distributor 26, which arranges a first reinforcement layer 6 on the first mixture of fiber segments and powder already present on the conveyor belt 11.

Downstream from the first reinforcement layer distributor 26 there is provided a second glass fiber rovings distributor 28 which can deliver glass fiber rovings 29 to a second chopper 30, which itself can deliver pieces of glass fiber rovings 31 to a second pin roller 32, which itself can break up the pieces of glass fiber rovings and mix them with a polyester resin powder received from a second powder distributor 33 and which then lets them drop onto the first reinforcement layer 6, forming a second mixture.

Downstream from the second pin roller 32 there is provided a second distributor 34 which can deliver either a second reinforcement layer 6a or a second web 7, and arrange it on the the assemblage of components present on the conveyor belt 11.

Downstream on the conveyor belt 11 there is provided an oven 24 able to heat the elements placed on the conveyor belt 11, and downstream from the oven 24 there are one or more pressing rollers 25 able to press the materials moving on the conveyor belt 11.

The oven 24 can be adjusted for example to a temperature of around 180° C., and the speed of movement of the conveyor belt 11 can be such that the heating produced by the oven 24 is sufficient to melt the polyester resin powder, yet low enough to prevent a melting of the other components of the reinforcement.

Thus, during the fabrication of the textile reinforcement 1 by the device 10, a first polyester web 5 is arranged on top of the conveyor belt 11 moving in the longitudinal direction I-I. With the first chopper 17, rovings of glass fiber 16 are chopped and made to drop onto the first pin roller 19, which at the same time receives the polyester resin powder coming from the first powder distributor 21. The mixture 20 of glass fiber segments mixed with the polyester resin powder drops onto the first web 5, itself having been placed on the moving conveyor belt 11, forming a first mixture. The reinforcement layer distributor 26 arranges the reinforcement layer 6 on the first mixture. The device allows one or other of the embodiments of textile reinforcement to be fabricated, as chosen by an operator.

According to a first mode of operation, the operator inhibits the operation of the second chopper 30, of the second powder distributor 33 and of the second pin roller 32, and the operation of the second distributor 34. During the passage through the oven 24, the polyester resin powder melts and is distributed around the glass fiber segments. The pressing rollers 25 encourage the formation of a sheet of constant thickness by pressing the melted resin powder on the glass fiber segments. The result at the exit of the device 10 is a textile reinforcement 1 according to the embodiment of FIG. 1.

According to a second mode of operation, the operator inhibits the operation of the second chopper 30, of the second powder distributor 33 and of the second pin roller 32 but uses the second distributor 34, adapting it to deliver a second web 7 and to arrange same on the first reinforcement layer 6. During the passage through the oven 24, the polyester resin powder melts and is distributed around the glass fiber segments. The pressing rollers 25 encourage the formation of a sheet of constant thickness by pressing the melted resin powder on the glass fiber segments. The result of the exit of the device 10 is a textile reinforcement 1 according to the embodiment of FIG. 5.

According to a third mode of operation, the operator uses all the components of the device, adapting the second distributor 34 to deliver a second reinforcement layer 6a. In this case, the second chopper 30, the second powder distributor 33 and the second pin roller 32 produce and apply to the first reinforcement layer 6 a second mixture of pieces of glass fiber rovings and polyester powder, and the second distributor 34 arranges the second reinforcement layer 6a on this second mixture. During the passage through the oven 24, the polyester resin powder melts and is distributed around the glass fiber segments. The pressing rollers 25 encourage the formation of a sheet of constant thickness by pressing the melted resin powder on the glass fiber segments. The result of the exit of the device 10 is a textile reinforcement 1 according to the embodiment of FIGS. 3 and 4.

As an alternative, the invention provides for the device to be designed for the fabrication of just one of the embodiments of textile reinforcement which are defined hereinabove.

Thus, to fabricate the textile reinforcement according to the embodiment of FIG. 1, there is no need to provide the means for producing the second mixture of fibers leaving the second pin roller 32 or to provide the second distributor 34.

In order to fabricate the textile reinforcement according to the embodiment of FIG. 5, the second distributor 34 is added and is then suited to delivering a second web 7.

In order to fabricate the textile reinforcement according to the embodiment of FIGS. 3 and 4, use is made of the device as illustrated in FIG. 7, adapting the second distributor 34 to deliver a second reinforcement layer 6a.

As a preferred example, the polyester powder may be an unsaturated bisphenol polyester resin. Such a powder is a commercially available product, for example, from C.O.I.M. S.p.A. with the reference FILCO® 661.

Alternatively, the polyester powder may be an unsaturated bisphenol polyester resin used in an aqueous emulsion, such as the ones commercially available from C.O.I.M. S.p.A with the references FILCO® 657 or FILCO® 659. Its drying temperature is 170 to 200° C. for 40 to 70 seconds. After cross linking, it becomes insoluble in styrene and acquires its bonding ability.

The present invention is not limited to the embodiments which have been explicitly described, and instead it includes the different variants and generalizations thereof contained in the scope of the following claims.

1-20. (canceled)

21. A textile reinforcement which can be used to make composite parts by pultrusion, comprising a reinforcement layer having segments of glass fiber oriented randomly and coated with a polyester binder,
wherein:
the reinforcement layer comprises at least one reinforcement layer formed of fibers structured by weaving, or by a grid, or by longitudinal and transverse threads,
the reinforcement layer comprises at least one thickness layer, adjacent to the reinforcement layer and based on said segments of glass fiber oriented randomly and coated with a polyester binder,
at least one first surface layer of fiber web forms a first external face of the textile reinforcement,
a second external face of the textile reinforcement is formed by said at least one reinforcement layer or by a second surface layer of fiber web,
the polyester binder bonds together the layers of the textile reinforcement.

22. The textile reinforcement as claimed in claim 21, wherein the glass fiber segments in said at least one thickness layer are pieces of fiber obtained from rovings of glass thread.

23. The textile reinforcement as claimed in claim 21, wherein the glass fiber segments comprise glass threads having a linear weight of 40 to 50 tex (40 to 50 grams per kilometer of thread).

24. The textile reinforcement as claimed in claim 21, wherein the polyester binder that binds together the layers of the textile reinforcement is an unsaturated bisphenol polyester, soluble or insoluble in styrene.

25. The textile reinforcement as claimed in claim 21, wherein the fibers forming said at least one reinforcement layer are continuous glass threads having an individual linear weight of 68 to 272 tex.

26. The textile reinforcement as claimed in claim 21, wherein the fibers forming said at least one reinforcement layer are rovings of continuous glass threads and have a linear weight of the roving of 320 to 1200 tex.

27. The textile reinforcement as claimed in claim 21, comprising the superposition of a first surface layer of fiber web forming a first external face of the textile reinforcement, followed by a first thickness layer based on said segments of glass fiber coated with polyester binder, itself followed by a reinforcement layer forming a second external face of the textile reinforcement.

28. The textile reinforcement as claimed in claim 21, comprising the superposition of a first surface layer of fiber web forming a first external face of the textile reinforcement, followed by a first thickness layer based on said segments of glass fiber coated in polyester resin, itself followed by a first reinforcement layer, followed by a second thickness layer based on said segments of glass fiber coated with polyester binder, itself followed by a second reinforcement layer.

29. The textile reinforcement as claimed in claim 21, wherein the surface layer or layers of fiber web are made of polyester, polyamide, or polypropylene, having a melting point higher than that of said polyester binder.

30. The textile reinforcement as claimed in claim 21, wherein, in the thickness layer or layers, the glass fiber segments have a length of 40 to 120 mm.

31. The textile reinforcement as claimed in claim 21, wherein the glass fiber segments are present in a quantity of 150 to 2000 grams per square meter.

32. The textile reinforcement as claimed in claim 21, wherein in the thickness layer or layers the polyester binder is present in a quantity of 3 to 5% by weight of the glass fibers.

33. A method of fabrication of a textile reinforcement usable in making composite parts by pultrusion, comprising the following consecutive steps:
a) on top of a conveyor belt moving in the longitudinal direction (I-I), arranging a first web of fibers made of polyester, polyamide or polypropylene,
b) cutting rovings of glass fiber and letting them drop onto a first pin roller at the same time receiving a polyester resin powder, making drop onto said first web placed on the moving conveyor belt a first mixture of segments of glass fiber and polyester resin powder, the polyester resin being chosen so as to have a melting point lower than that of the fibers making up the first web,
c) arranging a first reinforcement layer of reinforcing fibers on the first mixture of glass fiber segments and polyester resin powder,
f) heating the assemblage by passing through an oven so as to melt the polyester resin and ensure its distribution around the glass fiber segments, yet without melting the fibers of the first web.

34. The method as claimed in claim 33, comprising, prior to step f):
d) cutting rovings of glass fiber and letting them drop onto a second pin roller at the same time receiving a polyester resin powder, in order to make drop onto the first reinforcement layer of reinforcing fibers carried by the moving conveyor belt a second mixture of glass fiber segments and polyester resin powder, the polyester resin being chosen so as to have a melting point lower than that of the fibers making up the first web,
e) arranging a second reinforcement layer of reinforcing fibers on the second mixture of glass fiber segments and polyester resin powder.

35. The method as claimed in claim 33, wherein the first web is obtained by carding and has a surface density of 20 to 40 grams per square meter.

36. The method as claimed in claim 33, wherein the polyester resin has the property of melting when subjected to a temperature of 100° C. for two minutes.

37. The method as claimed in claim 33, wherein the polyester resin is in the form of a dry powder or in the form of a powder emulsion in water.

38. A device for the fabrication of a textile reinforcement as claimed in claim 21, comprising:
a conveyor belt providing movement between an entry roller and an exit roller,
near the entry roller, above the conveyor belt, a first web distributor for delivering a first web and for laying it on the conveyor belt,
downstream from the first web distributor, a first distributor of glass fiber rovings which can deliver glass fiber rovings to a first chopper,
at the exit from the first chopper, a first pin roller for breaking up the pieces of glass fiber rovings to produce glass fiber segments,
a first powder distributor for distributing a polyester resin powder on the first pin roller so that the polyester resin powder mixes with the glass fiber segments to form a first mixture during the depositing onto the first web,
downstream from the first pin roller, a first reinforcement layer distributor for arranging a first reinforcement layer on the first mixture of fiber segments and powder present on the conveyor belt,
downstream from the first reinforcement layer distributor, above the conveyor belt, a second glass fiber roving distributor which can deliver rovings of glass fiber to a second chopper, at the exit from the second chopper a second pin roller for breaking up the pieces of glass fiber rovings and producing glass fiber segments, a second powder distributor for distributing a polyester resin powder on the second pin roller so that the polyester resin powder mixes with the glass fiber segments to form a second mixture which is then arranged on the first reinforcement layer,
downstream from the second pin roller a second distributor able, as an operator so chooses, to deliver either a second reinforcement layer or a second web which it arranges on the second mixture coming from the second pin roller,
an oven able to heat the elements placed on the conveyor belt,
downstream from the oven, one or more pressing rollers able to press the materials moving on the conveyor belt.

39. The device as claimed in claim 38, wherein the second distributor is arranged downstream from the oven.

40. The use of a textile reinforcement as claimed in claim 21 to form a pultruded product, wherein the textile reinforcement taken alone is impregnated with a thermosetting plastic resin, and said impregnated textile reinforcement is drawn through a pultrusion die heated to a temperature that allows the thermosetting plastic resin to cross-link.
